(19) United States
(12) Patent Application Publication
(10) Pub. No.: US 2003/0118704 A1
(43) Pub. Date: Jun. 26, 2003

(54) Process for preserving food products

(75) Inventors: Bert Theo De Vegt, Rotterdam (NL); Elize Willem Bontenbal, Wageningen (NL)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(73) Assignee: PURAC BIOCHEM B.V., Gorinchem (NL)

(21) Appl. No.: 10/315,173

(22) Filed: Dec. 10, 2002

(30) Foreign Application Priority Data
Dec. 11, 2001 (EP) 01204794.0

(51) Int. Cl. A23L 1/27

(52) U.S. Cl. 426/267

(57) ABSTRACT

The present invention relates to a process for preserving food products using a combination of calcium lactate and a sequestering agent. The sequestering agent can be selected from citric acid, tartaric acid, maleic acid, oxalic acid, ascorbic acid, ertythorbic acid, phosphoric acid, salts and mixtures thereof. With this combination of the invention food products, including meat, can be preserved, while maintaining flavour, colour, and water holding capacity of the food product

The present invention relates to a process for preserving food products and to food products treated according to the invention. The invention also relates to an additive to be used in preserving food products.

It is known that calcium lactate has antimicrobial activity and that it can be used as a an additive in meat. In R. A. Weaver. L. A. Shelef, Journal Of Food Safety, 13, (1993), p. 133-146 the antilisterial activity of sodium, potassium of calcium lactate in pork liver sausage is compared. It is concluded that the effect of calcium salt is superior to that of either the sodium or the potassium salt.

However, when calcium lactate is used in meat as a single ingredient it slows down the curing reaction and affects the water holding capacity of the meat. Further, free calcium ions form bonds with proteins which has a sinking effect on the meat system. which forces water out of the system. The result is more cooking loss. It also changes the texture of the meat product making it more gummy and elastic. It can make the product harder. Calcium lactate may also cause a bitter taste.

The object of the invention is to preserve food products, including meat, while maintaining flavour, colour and, in particular in meat, water holding capacity of the food product. Another object of the invention is to provide a system for preserving foods having a neutral pH, i.e. foods in which the conventional preserving method of lowering pH cannot be applied

The present invention provides a process for preserving a food product, wherein calcium lactate and a sequestering agent are added to the food product.

By means of the present process calcium lactate can be added in relatively largo amounts, thus securing its preservative effect, while maintaining the quality, in respect of colour, taste and water holding capacity, of the final product.

The weight ratio of calcium lactate to sequestering agent is between 1:0.1 and 1:2 and preferably between 1:0.2 and 1:0.5. Based on the total weight of the food product, the amount of calcium lactate added is 0.05 to 3 wt. %. Below 0.05 wt. % the calcium lactate no longer provides it preserving action. Above 3 wt. % the taste of the food product is too much affected by the taste of the calcium lactate. In particular the amount of calcium lactate is from 0.2 to 1.5 wt. %. The amount of sequestering agent added is 0.05 to 3 wt. %.

Preferred sequestering agents are citric acid, tartaric acid, maleic acid, oxalic acid, ascorbic acid, erythorbic acid, phosphoric acid and salts thereof Also mixtures of two or more sequestering agents can be used. Suitable salts are sodium and potassium salts of these acids, such as trisodium and tripotassium citrate, disodium or dipotassium hydrogencitrate or sodium or potassium dihydrogencitrate. In particular citrate or phosphate is used as the sequestering agent.

It is advantageous if, beside calcium lactate and the sequestering agent, also sodium acetate and/or sodium diacetate is added to the food product. This increase the antimicrobial action of the product.

Food products that can be treated according to the invention are meat products, such as cooked and uncooked, cured and uncured meat. The invention is also suitable for other food products with limited shelf life having a pH of 5 to 8, for instance ready to eat meals, ready to cook meals, fresh pastas, soups or sauces.

The invention thus also relates to food products, in particular of the type as mentioned above which contain calcium lactate and a sequestering agent, preferably in an amount of 0.05 to 3 wt. % calcium lactate and 0.05 to 3 wt. % sequestering agent.

The invention also provides an additive for preserving food products, which can be added as such to the food product and which contains calcium lactate and a sequestering agent. The additive can further contain sodium acetate and/or sodium diacetate.

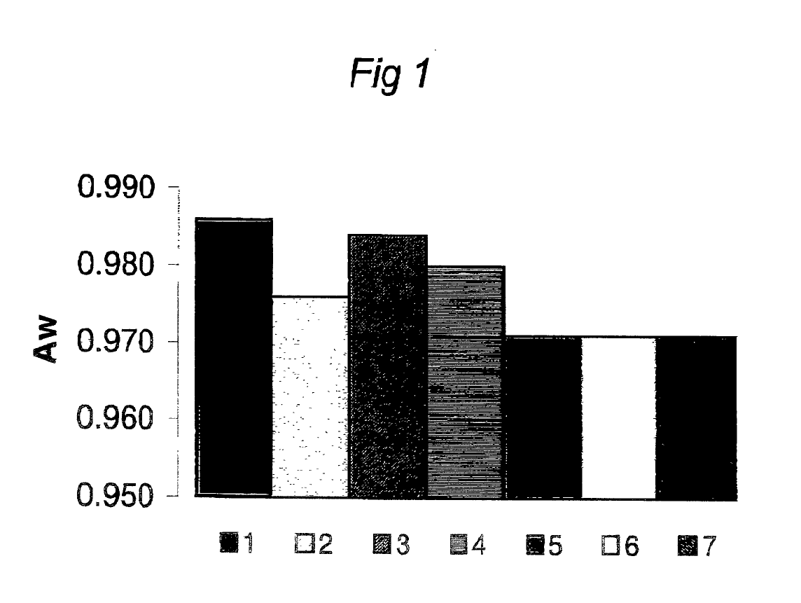

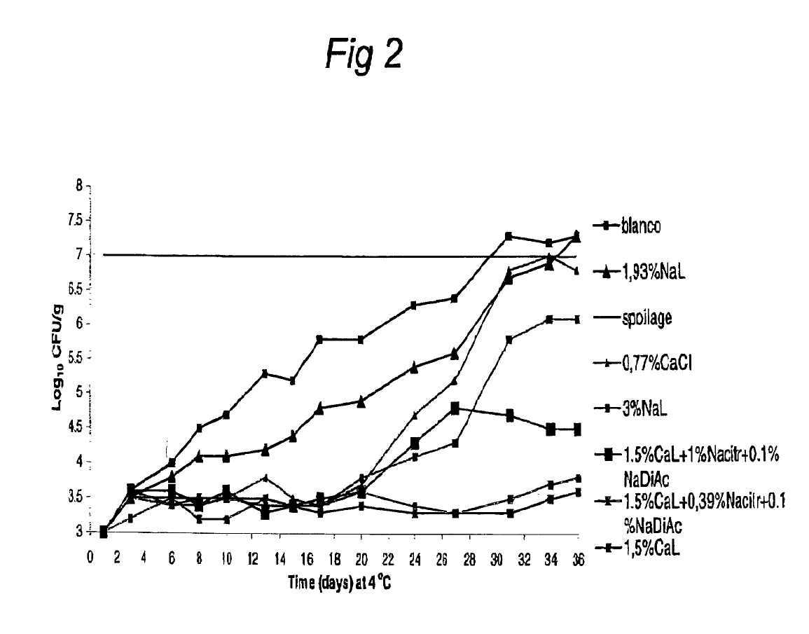

The invention is further illustrated in the examples and figures, wherein FIG. 1 shows the water activity of different preservatives and FIG. 2 shows the microbial characteristics of cooked sausages treated with different preservatives.

### EXAMPLE

Cooked sausages are prepared. To the sausages the following preservatives are added (table 1). The cooked sausages arc inoculated with Listeria innocua and counted on PCA during 35 days.

TABLE 1
Preservatives added to cooked sausages

| | | | Content |
|---|---|---|---|
| Sample | Composition | Variations | (%(w/w)) |
| 1 | Control | No preservatives added | 0 |
| 2 | Calcium lactate | | 1.5 |
| 3 | Sodium lactate | | 3.0 |
| 4 | Calcium chloride | Molar equivalent based on cal- | 0.77 |
| | | cium in sample 2 | |
| 5 | Sodium lactate | Molar equivalent based in lac- | 1.93 |
| | | tate in sample 2 | |
| 6 | Calcium lactate | | 1.5 |
| | Sodium citrate | Sequestrant | 0.39 |
| | Sodium-di-acetate | (1:0.25)(mol Ca:mol citrate) | 0.1 |
| 7 | Calcium lactate | | 1.5 |
| | Sodium citrate | Sequestrant | 1.0 |
| | Sodium-di-acetate | (1:0.63)(mol Ca:mol Citrate) | 0.1 |

Sensory Results

Sensory tests were carried out with the cooked sausages giving the following results.

TABLE 2
Sensorial properties of the cooked sausages

| | Color after | Color after cooling | Moisture | |
|---|---|---|---|---|
| Sample | pasteurization | (7° C.) | separation | Taste |
| 1 | Pink (normal) | Pink (normal) | None | Normal |
| 2 | Very gray | Pink (normal) | Yes, a lot | Bitter and |
| | | | | dry |
| 3 | Pink | Pink (normal) | None | Normal |
| 4 | Gray | Pink (normal) | Yes | Better than 2 |
| 5 | Pink | Pink (normal) | None | Normal |
| 6 | Gray/pink | Pink (normal) | Yes, but | Better |
| | | | less than 2 | |
| 7 | Gray/Pink | Pink (normal) | Yes, but | Too strong |
| | | | less than 2 | and salty |

Water Activity

All used preservatives reduce the water activity in the sausage, which can lead to a decrease in bacteria growth. Results of water activity arc shown in FIG. 1.

Shelf Life Extension

Microbial characteristics of the cooked sausages are shown in FIG. 2. This figure shows that calcium lactate has a very good effect on shelf life extension. Both sodium lactate and calcium chloride (used at the same lactate or calcium level, respectively, as calcium lactate) perform less than calcium lactate. This shows that the preservative effect of calcium lactate is based on the combination of calcium and lactate. The preservative properties of calcium lactate are not affected by the addition of sodium citrate.

1. Process for preserving a food product, wherein calcium lactate and a sequestering agent are added to the food product.

2. Process according to claim 1, wherein the weight ratio of calcium lactate to sequestering agent is between 1.0:1 and 1:2, preferably between 1:0.2 and 1:0.5.

3. Process according to claim 1 or 2, wherein the amount of calcium lactate is 0.05 to 3 wt. % based on the total weight of the food product.

4. Process according to any of claims 1 to 3, wherein the amount of sequestering agent is 0.05 to 3 wt. % based on the total weight of the food product.

5. Process according to any of claims 1 to 4, wherein the sequestering agent is selected from citric acid, tartaric acid, maleic acid, oxalic acid, ascorbic acid, erythorbic acid, phosphoric acid, salts thereof and mixtures thereof.

6. Process according to claim 5, wherein the sequestering agent is citrate or phosphate.

7. Process according to any of the preceding claims, which further comprises adding sodium acetate or sodium diacetate to the food product.

8. Process according to any of the preceding claims, wherein the food product is a meat product.

9. Process according to any of claims 1 to 7, wherein the food product is a ready to eat meal, ready to cook meal, a pasta, soup or sauce.

10. Food product containing calcium lactatc and a sequestering agent.

11. Food product according to claim 10, containing 0.05 to 3 wt. % calcium lactate and 0,05 to 3 wt. % sequestering agent.

12. Additive for preserving food products, containing calcium lactate and a sequestering agent.

13. Additive according to claim 12, further containing sodium acetate and/or sodium diacetate.
